(19) United States
(12) Patent Application Publication
(10) Pub. No.: US 2011/0313819 A1
(43) Pub. Date: Dec. 22, 2011

(54) BUSINESS MANAGEMENT SYSTEM AND PORTABLE TERMINAL DEVICE

(75) Inventor: Yoshikazu Nakamura, Nishikasugai-gun (JP)

(73) Assignee: MOBILE SYSTEMS CO., LTD., Nishikasugai-gun (JP)

(21) Appl. No.: 13/203,595

(22) PCT Filed: Feb. 25, 2010
(86) PCT No.: PCT/JP2010/052963

§ 371 Date: Aug. 26, 2011

(30) Foreign Application Priority Data
Feb. 27, 2009 (JP) 2009-046728

(51) Int. Cl. G06Q 10/00; G06Q 30/00

(52) U.S. Cl. 705/7.39

(57) ABSTRACT

Provided is a business management system that performs a business management of a plurality of stores in a collective manner. The system includes a first terminal device, a second terminal device, and a management server. The first terminal device sets a time at which a first operation is inputted by a visitor via an input device installed in the store as a visiting time, and generates a visitor number for sequentially leading the visitor while associating the visitor number with the visiting time. The second terminal device inputs the visitor number and a preset second operation. The management server obtains a service time (a time period from a service start time till a service end time) and a waiting time (a time period from the visiting time till the service start time), and aggregates the service time and the waiting time on a time-series basis for each store.

### TECHNICAL FIELD

The present invention relates to a business management system that performs a business management of a plurality of stores in a collective manner, and a portable terminal device constituting the system.

### BACKGROUND ART

Conventionally, a business management system is known in which employees' works are managed using a personal computer (PC) in order to perform an evaluation of the employees and an analysis of the works. An example of this kind of business management system is described in Patent Literature 1 (Unexamined Japanese Patent Application Publication No. H07-325870), in which a PC is configured to perform a first processing, a second processing, a third processing, and the like.

The first processing is to register an employee, a project, a work item and the like while associating them with each other. The second processing is to store a start/end date and time of each work item, which is inputted by an employee or a supervisor, as log information.

The third processing is to aggregate a time period spent by each employee for each project or for each work item (work content) based on the log information.

Patent Literature 1: Unexamined Japanese Patent Application Publication No. H07-325870

### SUMMARY OF THE INVENTION

### Problems to be Solved by the Invention

According to a conventional business management system, aggregating a time period spent by each employee for each work content makes it possible to evaluate an individual employee based on the aggregated data. However, in a case where a plurality of stores are managed in a collective manner, it is impossible to evaluate whether or not works are effectively performed in each store. In other words, there is a problem with a function of the conventional business management system in that the function is insufficient to evaluate effectiveness in each store. Incidentally, in each store, a work to serve a visitor for sale of goods and/or provision of service (service at the window) is carried out.

In a business management system of the present invention, it is preferable that allocation of management resources to a plurality of stores, in which the service at the window is carried out, can be enabled to be performed easily and effectively.

### Means for Solving the Problems

A first aspect of a business management system of the present invention is a system that performs a business management of a plurality of stores, in which a service at the window is carried out, in a collective manner. The business management system includes a first terminal device, a second terminal device, and a management server.

The first terminal device sets or recognizes a time at which a first operation is inputted via an input device installed in a store as a visiting time. Here, the first operation refers to a preset operation performed by a visitor to the store. Then, the first terminal device generates a visitor number for leading the visitor to the window in a sequential order while associating the visitor number with the visiting time.

The second terminal device executes a processing that inputs the visitor number generated by the first terminal device and a second operation. Here, the second operation refers to a preset operation performed by an employee of the store.

The service at the window includes overall works carried out when dealing with the visitor. The window refers to a place where such overall works are carried out (space for serving visitors).

The management server obtains a service time and a waiting time via an input from the second terminal device.

Then, the management server aggregates the service time and the waiting time on a time-series basis for each store.

The service time refers to a time period from a service start time till a service end time. The waiting time refers to a time period from the visiting time to the service start time.

The service start time refers to a time at which the visitor number is inputted via the second terminal device. The service end time refers to a time at which the second operation is inputted via the second terminal device.

In the business management system configured as such, the service time and the waiting time aggregated by the management server for each store are comprehended by a part that manages the plurality of stores, in which the service at the window is carried out, in a collective manner (hereinafter referred to as a management part). As a result, it becomes possible for the management part to perform an evaluation regarding effectiveness in each store, such as whether or not works are effectively performed at each store, based on a ratio of the service time to the waiting time, for example.

Therefore, according to the business management system of the present invention, it becomes possible for the management part to easily adjust a number of employees (human resources) in these individual stores as mentioned above based on the evaluation regarding effectiveness in each store (work evaluation). Consequently, the management part can easily and effectively allocate management resources to the plurality of stores, in which the service at the window is carried out.

In addition, according to the business management system of the present invention, to have the management part comprehend the service time and the waiting time aggregated by the management server on a time-series basis enables the management part to adjust the number of employees in each store based on the work evaluation at each clock time. Consequently, the management part can, for example, allocate part-time employees and non-regular workers appropriately to each store.

In the business management system of the present invention, it is preferable that the first terminal device is a fixed terminal device that performs wired communications with the management server. Further, it is preferable that the second terminal device is a portable terminal device that performs wireless communications with the fixed terminal device in the store.

According to the business management system configured as such, the second terminal device (portable terminal device) required to be operated by the employee of the store can be easily carried around in the store by the employee. Therefore, the space for serving visitors does not need to be limited and, furthermore, a space in the store can be efficiently utilized. In this case, the portable terminal device can transmit the visiting time, the service start time, and the service end time to the management server via the fixed terminal device.

In the business management system of the present invention, the portable terminal device may transmit a first time information, which includes the service start time and the service end time, to the fixed terminal device while associating the first time information with the visitor number. Then, when receiving the first time information from the portable terminal device, the fixed terminal device may transmit a second time information, in which the visiting time, the service start time, and the service end time are associated based on the visitor number, to the management server. Subsequently, it is preferable that, when receiving the second time information from the fixed terminal device, the management server aggregates a number of served visitors and a number of waiting visitors per unit time for each store by counting the service time and the waiting time.

According to the business management system configured as such, to have the management part comprehend the number of the served visitors and the number of the waiting visitors aggregated by the management server per unit time for each store enables the management part to easily evaluate whether the number of the employees in each store at each clock time is appropriate or not based on, for example, a ratio of the number of the served visitors to the number of the waiting visitors.

In the business management system of the present invention, it is preferable that the fixed terminal device outputs a ticket having a visitor identification code for identifying the visitor number affixed thereto, and that the portable terminal device includes a reading unit that reads an identification code for identifying information and inputs the visitor number by reading the visitor identification code affixed to the ticket via the reading unit.

According to the business management system configured as such, the visitor number can be inputted just by the employee passing the reading unit of the portable terminal device over the visitor identification code on the ticket. Further, a time at which the visitor number is inputted can be easily specified as the service start time.

Additionally, in the business management system of the present invention, the portable terminal device may input an employee ID, which has been assigned to each employee in advance, by reading an employee identification code for identifying the employee ID via the reading unit, and may transmit the first time information to the fixed terminal device while associating the first time information with the employee ID. Then, when receiving the first time information from the portable terminal device, the fixed terminal device may transmit work information, which has been associated with the employee ID and the second time information based on the visitor number, to the management server. Subsequently, when receiving the work information from the fixed terminal device, the management server may aggregate the service time for each employee ID.

According to the business management system configured as such, to have the management part comprehend the number of the served visitors per unit time (processing capability) aggregated by the management server for each employee enables the management part to effectively allocate the human resources to each store in accordance with the processing capability of each employee.

In the business management system of the present invention, when a content of service is inputted via the second operation, the portable terminal device may transmit the first time information to the fixed terminal device while associating the first time information with the content of service. Then, when receiving the first time information from the portable terminal device, the fixed terminal device may transmit the work information to the management server while associating the content of service with the work information based on the visitor number. Subsequently, when receiving the work information from the fixed terminal device, the management server may aggregate the content of service while associating the content of service with the service time. Specifically, in a case where a main body of the portable terminal device is provided with a display unit and an input unit, it is possible that the second operation is an operation in which any of images corresponding to a plurality of the contents of service displayed on the display unit are selected/decided by the input unit.

According to the business management system configured as such, to have the management part comprehend the processing capability of each employee aggregated by the management server for each content of service enables the management part to evaluate the processing capability of each employee more properly.

Incidentally, in the business management system of the present invention, the portable terminal device may input a goods ID assigned to each goods in advance by reading a goods identification code for identifying the goods ID via the reading unit, and may count a number of times the goods ID has been inputted as a quantity of inventory of the goods corresponding to the goods ID. Then, the management server may aggregate the quantity of inventory of each goods in each store via the portable terminal device.

In such a case, the inventory of the goods in the store can be counted just by the employee passing the reading unit of the portable terminal device over the goods identification code affixed to each goods, for example. Therefore, an inventory taking in the store can be easily conducted. According to the business management system configured as such, it is possible to have the management side easily comprehend the quantity of inventory of each goods aggregated by the management server for each store. As a result, the management part can promptly allocate each goods to each store (a number to be warehoused).

On the other hand, in the business management system of the present invention, the management server may transmit the number of each goods to be warehoused to the fixed terminal device while associating the number of each goods to be warehoused with the goods ID. The portable terminal device may include a first storage unit that stores the quantity of inventory of a goods corresponding to the goods ID. In addition, when receiving the number of each goods to be warehoused via the fixed terminal device, the portable terminal device may add the number of the goods to be warehoused to the quantity of inventory of the goods corresponding to the goods ID, which is stored in the first storage unit.

In such a case, the employee does not need to perform a process of warehousing the goods, and the quantity of inventory of the goods stored in the portable terminal device is automatically updated. As a result, it can save the employee the trouble associated with the process of warehousing, and the time spent by the employee on other than the service at the window (the time spent on back-office works) can be reduced.

Further, in the business management system of the present invention, the management server may transmit a sales price of each goods to the fixed terminal device while associating the sales price with the goods ID. Besides, the portable terminal device may include a second storage unit that stores a sales price of the goods corresponding to the goods ID. In addition, when receiving the sales price of each goods via the fixed terminal device, the portable terminal device may update the sales price of the goods corresponding to the goods ID, which is stored in the second storage unit.

In such a case, the sales price of each goods decided by the management part can be promptly reflected in each store. According to the business management system configured as such, the employee does not need to perform a process of inputting the sales price, and the sales price of the goods stored in the portable terminal device is automatically updated. Due to this, miscommunication from the management part to the store part can be avoided, and the management part can manage the sales price in each store effectively.

In the business management system of the present invention, when a service item is inputted via the first operation, the fixed terminal device may transmit the visitor number to the portable terminal device while associating the visitor number with the service item. It is preferable that, when receiving the visitor number from the fixed terminal device, the portable terminal device displays the visitor number in numerical order for each service item. Specifically, it is possible that the first operation is an operation in which any of soft-keys corresponding to a plurality of the service items displayed on a display panel is depressed via the input device constituted of a touch panel integrally arranged on a surface of the display panel.

According to the business management system configured as such, the employee can know the service item (and the content of service) desired by the visitor prior to the service based on the display by the portable terminal device. As a result, the employee with much knowledge about the service can serve the visitor smoothly for each service.

A portable terminal device as a second aspect of the present invention is a portable terminal device constituting a business management system. The business management system includes a fixed terminal device, a management server, and the portable terminal device. The business management system performs a business management of a plurality of stores in a collective manner.

The fixed terminal device generates a visitor number for leading a visitor to the window in a sequential order while associating the visitor number with a visiting time. The visiting time is a time at which a preset first operation performed by the visitor to the store is inputted via an input device installed in the store, in which the service at the window is carried out. The management server performs wired communications with the fixed terminal device. The portable terminal device of the present invention performs wireless communications with the fixed terminal device in the store.

The portable terminal device includes an input device and a transmission device.

The input device inputs the visitor number generated by the fixed terminal device and a preset second operation.

The transmission device transmits the visiting time, a service start time, and a service end time via the fixed terminal device. The service start time is a time at which the visitor number is inputted via the input device. The service end time is a time at which the second operation is inputted.

The management server aggregates the service time and the visiting time on a time-series basis. The service time is a time period from the service start time till the service end time. A waiting time is a time period from the visiting time till the service start time.

The portable terminal device configured as such can be preferably used for the above-described business management system.

### BRIEF DESCRIPTION OF THE DRAWINGS

FIG. 1 is a block diagram showing a configuration of a business management system 1, to which the present invention is applied.

FIG. 2A is a block diagram showing a configuration of an issuing terminal 2 constituting the business management system 1. FIG. 2B is a first explanatory diagram showing a display screen of a display panel 11.

FIG. 3 is a block diagram showing a configuration of a handy terminal 3 constituting the business management system 1.

FIG. 4 is a flowchart showing details of a service preparation processing executed by a CPU in a control unit 25.

FIG. 5 is a flowchart showing details of a service-at-the-window processing executed by the CPU in the control unit 25.

FIGS. 6A-6C are first explanatory diagrams showing screens displayed on a display unit 24 while the service-at-the-window processing is executed.

FIGS. 7A-7C are second explanatory diagrams showing screens displayed on the display unit 24 while the service-at-the-window processing is executed.

FIGS. 8A-8C are third explanatory diagrams showing screens displayed on the display unit 24 while the service-at-the-window processing is executed.

FIG. 9 is a block diagram showing a configuration of a management server 4 constituting the business management system 1.

FIG. 10 is an explanatory diagram showing conditions of presenting data aggregated by the management server 4.

FIGS. 11A-11C are first explanatory diagrams showing the data aggregated by the management server 4.

FIGS. 12A-12B are second explanatory diagrams showing the data aggregated by the management server 4.

FIGS. 13A-13B are third explanatory diagrams showing the data aggregated by the management server 4.

FIG. 14 is a fourth explanatory diagram showing a screen displayed on the display unit 24 while the service-at-the-window processing is executed.

FIGS. 15A-15B are second explanatory diagrams showing display screens of the display panel 11 of the issuing terminal 2.

FIG. 16 is an explanatory diagram showing another example of a display screen of the display panel 11 of the issuing terminal 2.

FIG. 17 is an explanatory diagram showing other examples of screens displayed on the display unit 24.

FIG. 18 is an explanatory diagram showing screens displayed on the display unit 24 and related to options.

FIG. 19 is an explanatory diagram showing display contents in a management PC 5.

FIG. 20 is an explanatory diagram showing an example of a main screen in the management PC 5.

FIG. 21 is an explanatory diagram showing an example of comprehensive detailed screen in the management PC 5.

FIG. 22 is an explanatory diagram showing an example of a daily report screen in the management PC 5.

### EXPLANATION OF REFERENTIAL NUMERALS

1 . . . business management system; 2 . . . issuing terminal; 3 . . . handy terminal; 4 . . . management server; 11 . . . display panel; 12 . . . touch panel; 13 . . . input device; 14 . . . control device; 15 . . . thermal printer; 16 . . . communication device; 17 . . . network I/F; 21 . . . input unit; 22 . . . reading unit; 23 . . . communication unit, 24 . . . display unit; 25 . . . control unit; 31 . . . network I/F; 32 . . . database unit, 33 . . . control unit.

### MODES FOR CARRYING OUT THE INVENTION

A first embodiment of the present invention is explained below with reference to the drawings.

### First Embodiment

<Total Configuration>

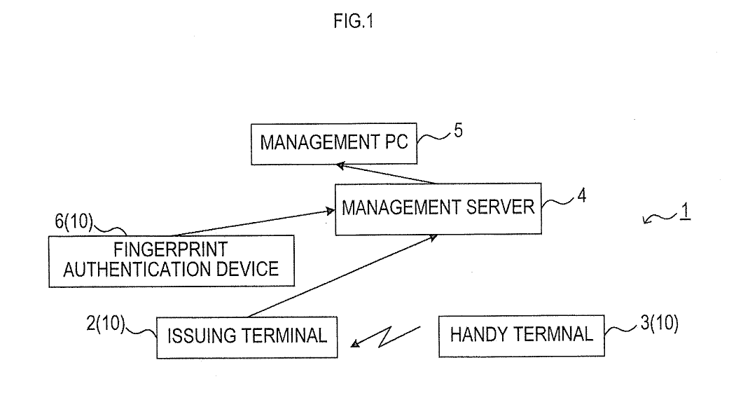

A business management system 1 of the present embodiment as shown in FIG. 1 is a system for managing a plurality of stores 10 in a collective manner. In each store 10, a work to serve a visitor for sale of goods and/or provision of service (hereinafter referred to as service at the window) is carried out. Further, it is assumed that sales and repair of a mobile phone, conclusion of a contract regarding a mobile phone, some changes to the contract, and the like are carried out as the service at the window in each store 10.

As shown in FIG. 1, the business management system 1 includes an issuing terminal 2 (an example of a fixed terminal device), a handy terminal 3 (an example of a portable terminal device), and a management server 4. The issuing terminal 2 is provided at a predetermined location in each store 10. The handy terminal 3 performs communications with the issuing terminal 2 using a known wireless communication technology such as a wireless LAN and Bluetooth (registered trademark). The management server 4 performs communications with the issuing terminal 2 using a known wired network technology via the Internet, a private communication line, or the like.

In the business management system 1 of the present embodiment, the management server 4 is built as a web server (www server) on the Internet. The management server 4 is configured, when receiving a predetermined ID and a predetermined password from a terminal device (hereinafter referred to as a management PC) 5 of a part managing business of all the stores 10 in a collective manner (hereinafter referred to as a management part) via the Internet, to allow the management PC 5 to browse various data and/or to execute various programs in the management server 4.

In the business management system 1 of the present embodiment, a fingerprint authentication device 6 is provided in each store 10. The fingerprint authentication device 6 is a device for inputting fingerprint information as authentication information of an employee. The business management system 1 is so configured that, when the fingerprint information of the employee is inputted via the fingerprint authentication device 6, a time at which the fingerprint information is inputted is transmitted to the management server 4 via the Internet as an arrival time or a departure time.

<Configuration of the Issuing Terminal>

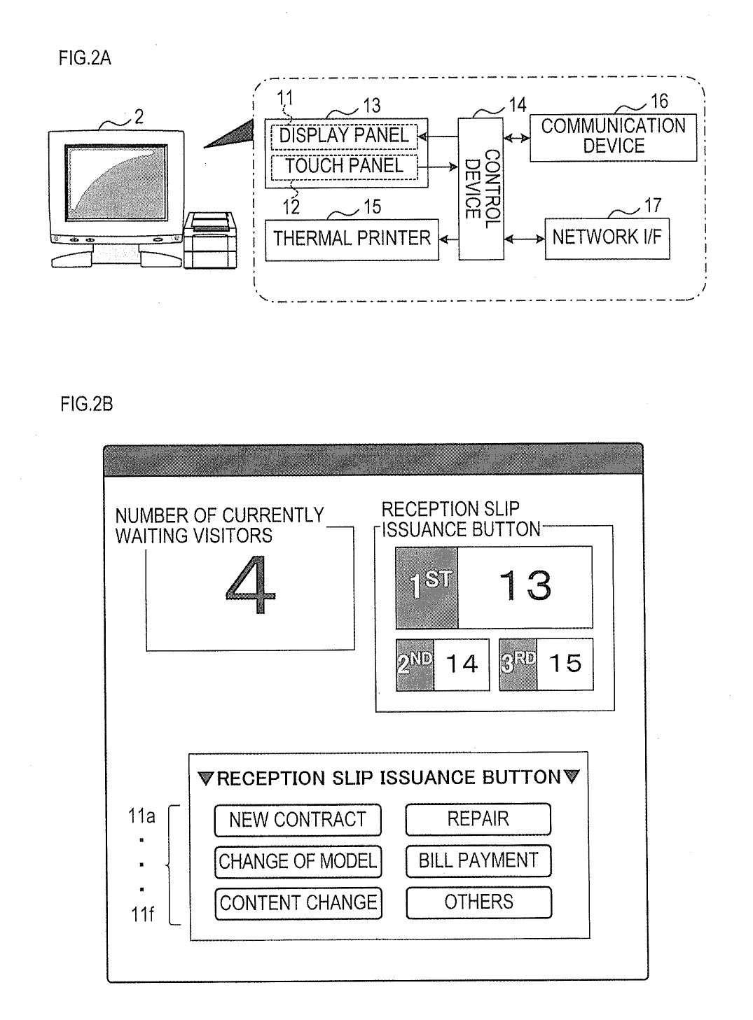

As shown in FIG. 2A, the issuing terminal 2 includes an input device 13, a control device 14, a thermal printer 15, a communication device 16, and an interface (hereinafter referred to as a network I/F) 17.

The input device 13 is constituted of a touch panel 12 integrally arranged on a surface of a display panel 11. The control device 14 generates a visitor number for leading the visitor to the window of the store 10 in a sequential order when the input device 13 is operated by the visitor. The thermal printer 15 prints out a ticket (reception slip) having the visitor number generated by the control device 14 and a visitor identification code (bar-code in the present embodiment) for identifying the visitor number affixed thereto. The communication device 16 is a device for performing wireless communications with the handy terminal 3. The I/F 17 is an interface for performing wired communications with the management server 4.

The display panel 11 is a color display device. Any of a liquid crystal display, an organic EL display, and a CRT, for example, is used as the display panel 11. As shown in FIG. 2B, a number of waiting visitors, to-be-served visitor numbers (reception slip numbers), and soft keys 11a-11f are displayed on the display panel 11. The number of waiting visitors is a number of visitors who are waiting to be served. The to-be-served visitor number (reception slip number) is a number issued for each visitor and shows a visitor to be lead to the window (space for serving visitors) of the store 10. The soft keys 11a-11f are displayed buttons operated to issue the reception slip.

Each of the soft keys 11a-11f is provided with respect to each service item (i.e., content of service) desired by the visitor. The content of service includes a new contract, change of a model, change in a content of a contract (content change), repair, bill payment, and others, for example.

The touch panel 12 is laminated/integrated with the display panel 11. The touch panel 12 is so configured that a detection signal indicating the content of service desired by the visitor is inputted to the control device 14 by depressing or touch-controlling various buttons 11a-11f on the display panel 11. For the touch panel 12, any of various types such as a pressure sensitive type, an electromagnetic induction type, a capacitance type, a combined type of these, and the like is used.

The thermal printer 15 has a known configuration. Specifically, the thermal printer 15 generates the reception slip by transferring an image of the visitor number, the visitor identification code, and the like to a paper in accordance with a command from the control device 14 and passing the paper between a heater roller and a pressure roller to fix the image on the paper.

The control device 14 is constituted mainly of a known microcomputer including a CPU, a ROM, a RAM, an I/O, a bus line that connects these, and the like. The CPU executes various processings based on a program stored in the ROM.

Specifically, when the input device 13 receives a touch operation by the visitor, the CPU of the control device 14 sets a time at which the touch operation is performed (hereinafter also referred to as an input time) as a visiting time, and stores the visiting time in the RAM while associating the visiting time with a visitor number. Then, the CPU outputs a command signal to print out the reception slip based on the visitor number to the thermal printer 15. The CPU is configured to execute processings to increase the number of waiting visitors displayed on the display panel 11 and to rearrange an order of the reception slip numbers.

The CPU of the control device 14 transmits information indicating the content of service desired by the visitor and the visitor number to the handy terminal 3 via the communication device 16 while associating the content of service with the visitor number based on the detection signal from the input device 13. The CPU is configured, when receiving service information, which will be described later, from the handy terminal 3 via the communication device 16, to generate work information (including a second time information), which is composed by adding information indicating the visiting time to the service information based on the visitor number stored in the RAM and to transmit the work information to the management server 4 via the network I/F 17.

<Configuration of the Handy Terminal>

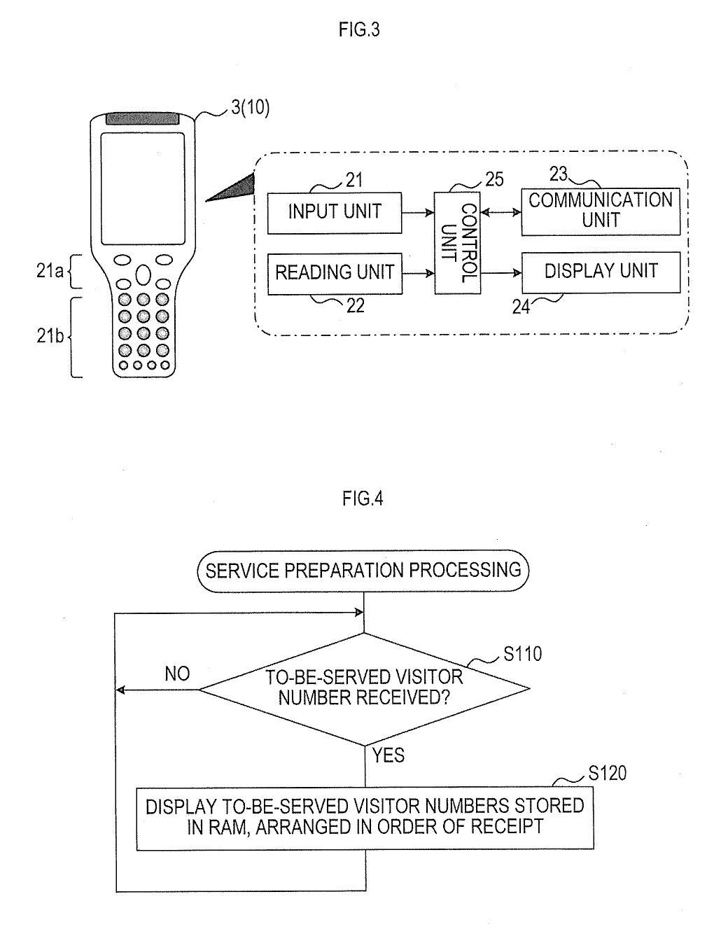

As shown in FIG. 3, the handy terminal 3 includes an input unit 21 (an example of an input device), a reading unit 22, a communication unit 23, a display unit 24, and a control unit 25. The input unit 21 is a structure for accepting various button operations by the employee of the store 10. The reading unit 22 reads various identification codes for identifying information. The communication unit 23 performs wireless communications with the issuing terminal 2. The display unit 24 displays an image of characters, graphics, and the like. The control unit 25 executes various processings in accordance with an input from the input unit 21, the reading unit 22, and the communication unit 23, and controls the display unit 24 and the communication unit 23.

The input unit 21 is provided on a grip section of a main body of the handy terminal 3, and is constituted of an input button 21a, a function button 21b, and the like. The input button 21a is a button for inputting numbers and characters. The function button 21b is a button for switching/selecting/executing various menus displayed on the display unit 24. The input unit 21 may be constituted of a touch panel integrally arranged on a surface of the display unit 24.

The reading unit 22 is provided at an extreme end part of the main body of the handy terminal 3, and is constituted of an image scanner. The image scanner optically reads an image of characters, graphics, and the like included in a medium, and converts the image to a digital data. The reading unit 22 of the present embodiment is configured to read a visitor identification code affixed to the reception slip and an employee identification code for identifying an employee ID, which has been assigned to each employee in advance, and thereby to input the visitor number and the employee ID to the control unit 25.

The control unit 25 is constituted mainly of a known microcomputer including a CPU, a ROM, a RAM, an I/O, a bus line that connects these, and the like. The CPU is configured to execute a service preparation processing and a service-at-the-window processing as below based on a program stored in the ROM.

<<Service Preparation Processing>>

The service preparation processing as shown in FIG. 4 is initiated when the handy terminal 3 is powered on, and is repeatedly executed until the handy terminal 3 is powered off.

In the present processing, the CPU determines whether the to-be-served visitor number has been received from the issuing terminal 2 via the communication unit 23 (S110). If the result of S110 is NO, the CPU waits to receive the to-be-served visitor number. On the other hand, if the result of S110 is YES, the CPU stores the to-be-served visitor number received in S110 in the RAM, and arranges the to-be-served visitor numbers stored in the RAM in order of receipt to display the arranged to-be-served visitor numbers on the display unit 24 (S120). Subsequently, the CPU executes the processing of S110.

<<Service-at-the-Window Processing>>

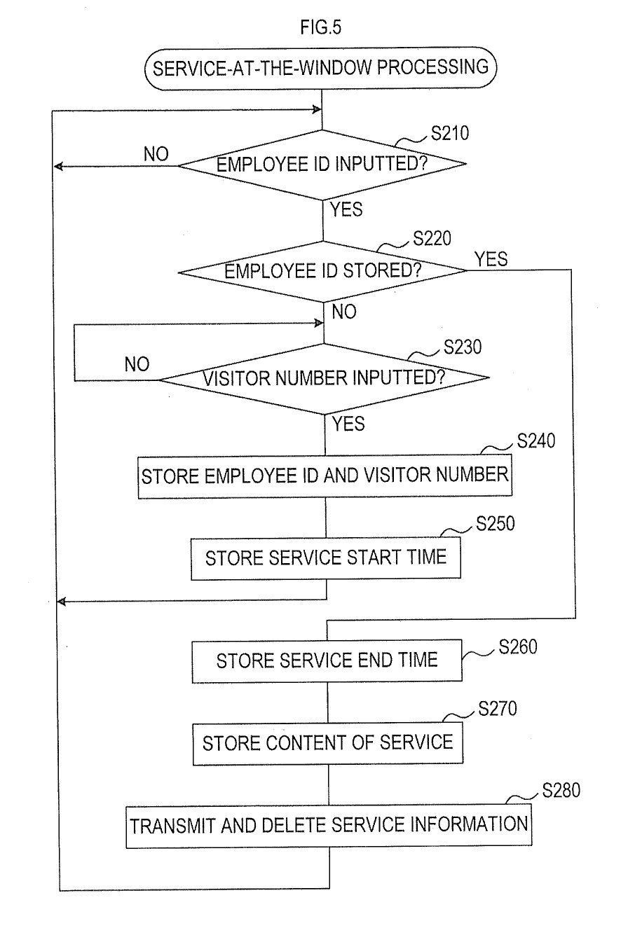

The service-at-the-window processing as shown in FIG. 5 is initiated when the above-described service preparation processing is started, and is repeatedly executed until the handy terminal 3 is powered off.

When this processing is started, the CPU displays a reception screen for accepting an input of the employee ID on the display unit 24, and determines whether or not the employee ID has been inputted via the reading unit 22 (S210). If the result of S210 is NO, the CPU waits for the employee ID to be inputted. On the other hand, if the result of S210 is YES, the CPU executes a processing of S220.

Then, the CPU determines whether or not the employee ID inputted in S210 is stored in the RAM (S220). If the result of S220 is NO, the CPU executes a processing of S230. On the other hand, if the result of S220 is YES, the CPU executes a processing of S260.

In S230, the CPU displays the reception screen for accepting the input of the visitor number on the display unit 24, and determines whether or not the visitor number has been inputted via the reading unit 22. If the result of S230 is NO, the CPU waits for the visitor number to be inputted. On the other hand, if the result of S230 is YES, the CPU executes a processing of S240.

In S240, the CPU displays a start button for confirming a start of the service at the window on the display unit 24, and stores both of the employee ID inputted in S210 and the visitor number inputted in S230 in the RAM while associating the both with each other. Then, when the start button is depressed via the input unit 21, the CPU executes a processing of S250.

In S250, the CPU sets a time at which the visitor number is inputted in S230 as a service start time, and stores the service start time in the RAM while associating the service start time with the to-be-served visitor number inputted in S230. Then, the CPU executes the processing of S210.

On the other hand, in S260, which is executed when the employee ID inputted in S210 is stored in the RAM, the CPU determines that the service at the window corresponding to the to-be-served visitor number corresponding to the employee ID has been completed, and sets the time at which the employee ID is inputted in S210 as a service end time. Subsequently, the CPU stores the service end time in the RAM while associating the service end time with the employee ID, and then executes a processing of S270.

In S270, the CPU displays content buttons for inputting a content of the service at the window (content of service) completed in S260 on the display unit 24, and stores the one or more contents of service corresponding to the content button depressed via the input unit 21 in the RAM while associating the contents of service with the service end time. Then, the CPU executes a processing of S280.

In 5280, the CPU transmits the service information (corresponding to a first time information) composed of the service end time stored in the RAM in S260, the service start time, the employee ID, the content of service, and the to-be-served visitor number to the issuing terminal 2 via the communication unit 23. The service start time, the employee ID, the content of service, and the to-be-served visitor number correspond to the service end time. Further, the CPU deletes the above information from the RAM. Then, the CPU executes the processing of S210. The processing of S280 as above is an example of a transmitting device.

<How to Use the Handy Terminal>

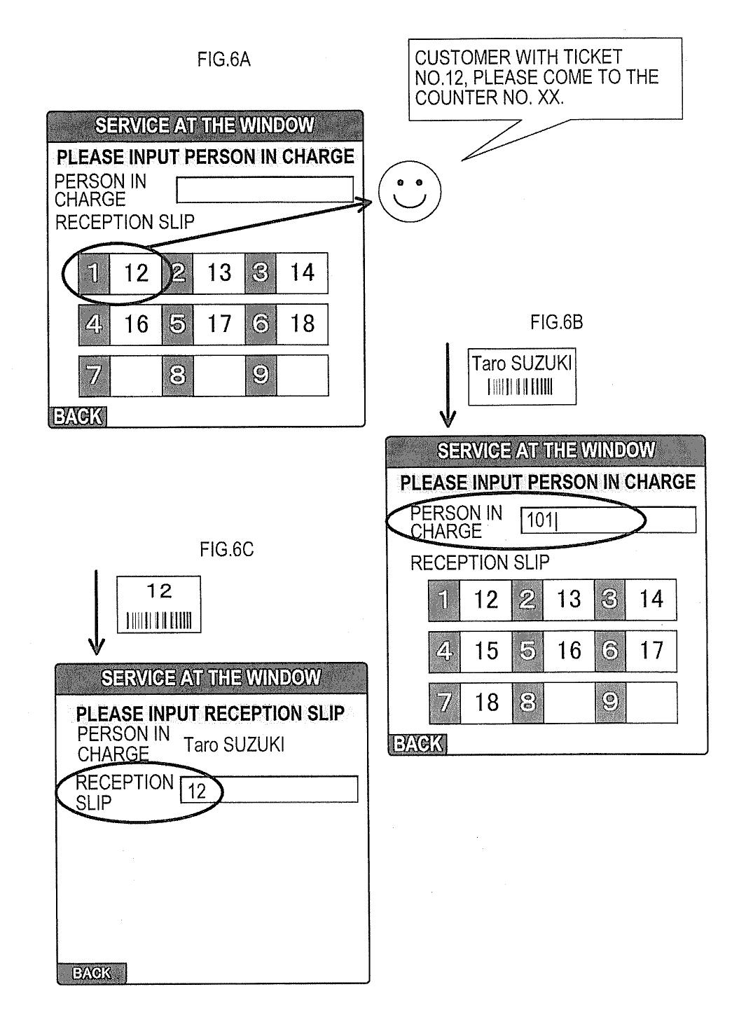

Next, how to use the handy terminal 3 is explained with reference to FIGS. 6A-8C.

Firstly, FIG. 6A is to be referred to. The employee in the store 10 leads the visitor to the window who has the reception slip having the leading to-be-served visitor number affixed thereto among the to-be-served visitor numbers displayed in numerical order on the display unit 24. At this point, the employee himself/herself may call out the to-be-served visitor number, or a prerecorded voice data may be outputted by means of a voice output device. In any case, misreading of a name of the visitor and/or a leakage of personal information can be inhibited because the visitor is led to the window using the to-be-served visitor number.

Next, FIG. 6B is to be referred to. The employee passes the reading unit 22 over the employee identification code affixed to his/her own name tag to scan his/her own employee ID. At this point, the scanned employee ID is inputted to/stored in the control unit 25.

Next, FIG. 6C is to be referred to. When receiving the reception slip from the visitor, the employee passes the reading unit 22 over the visitor identification code affixed to the reception slip to scan the visitor number. At this point, the scanned visitor number is inputted to the control unit 25 and stored associated with the employee ID. Incidentally, an input time of the visitor number here is stored in the control unit 25 as the service start time.

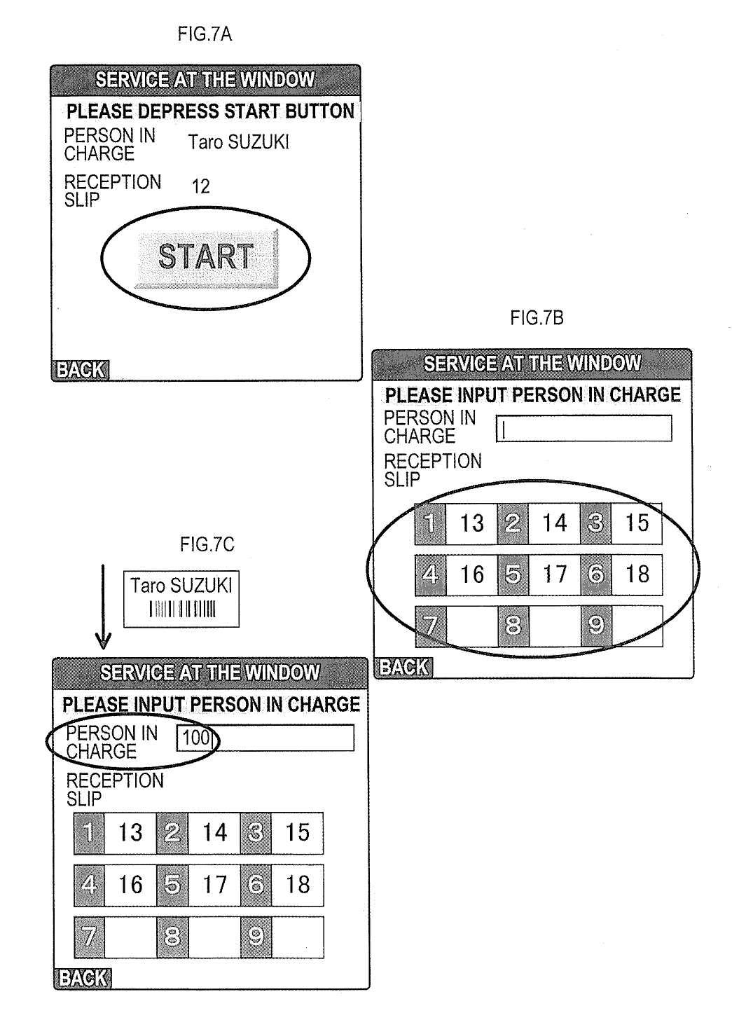

Subsequently, FIG. 7A is to be referred to. The employee confirms the start of the service at the window by depressing the start button displayed on the display unit 24 via an operation of the input unit 21. As shown in FIG. 7B, when the start button is depressed, the screen returns to an original state, in which the to-be-served visitor numbers are arranged in numerical order on the display unit 24. However, on the display screen here, the visitor number already scanned and inputted to the control unit 25 is deleted and the remaining visitor numbers are advanced and displayed in numerical order.

What is important here is that, in this state of the display screen, when another employee leads a visitor to the window in a same manner as described above and scans his/her own employee ID and a visitor number of the visitor, another service at the window can be started. In other words, since the employee ID inputted to the control unit 25 is stored separately associated with each to-be-served visitor number, a plurality of the services at the window can be carried out in parallel.

Next, FIG. 7C is to be referred to. When completing a service to the visitor led to the window, the employee passes the reading unit 22 over the employee identification code affixed to his/her own name tag again to scan his/her own employee ID. An input time of the employee ID here is stored in the control unit 25 as the service end time.

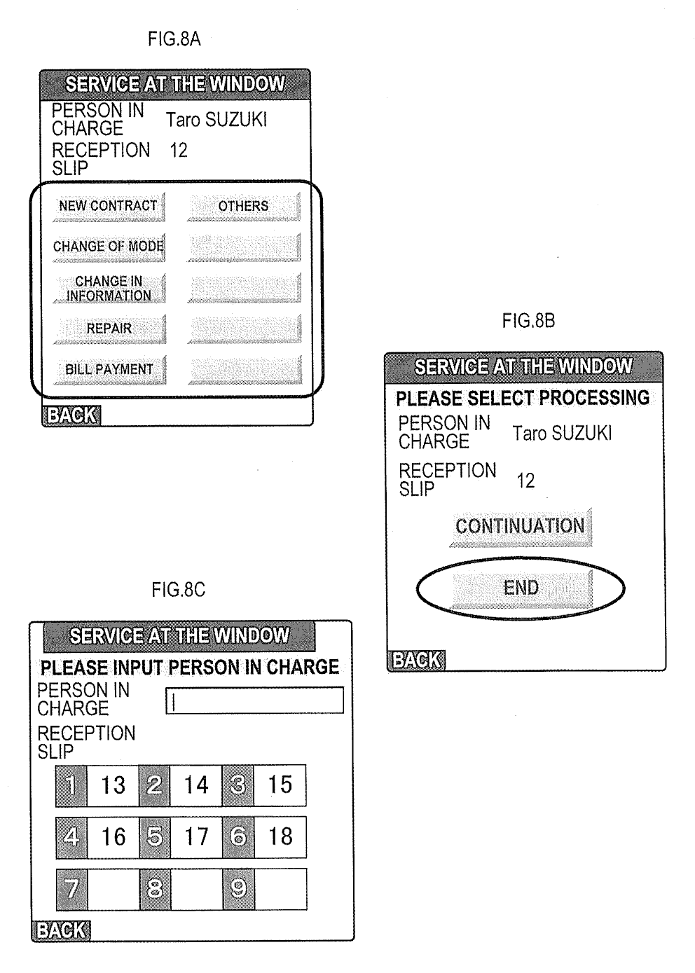

Next, FIG. 8A is to be referred to. The employee inputs the completed content of the service at the window (content of service) by depressing the content button displayed on the display unit 24 via an operation of the input unit 21. Next, FIG. 8B is to be referred to. The employee may input a plurality of the contents of service by depressing a continuation button displayed on the display unit 24 via an operation of the input unit 21. In any case, the employee depresses an end button displayed on the display unit 24 lastly via an operation of the input unit 21. At this point, the control unit 25 transmits the service information generated by associating the service start time, the service end time, the employee ID, and the content of service with the to-be-served visitor number to the issuing terminal 2 via the communication unit 23, and the above information is to be deleted from the RAM. The issuing terminal 2 that receives the service information is to transmit the work information, which is composed by adding the visiting time to the service information, to the management server 4 via the network I/F 17.

When the operations so far are carried out by the employee, the screen of the display unit 24 is to return to the original state in which the to-be-served visitor numbers are displayed in numerical order as shown in FIG. 8C.

<Configuration of the Management Server>

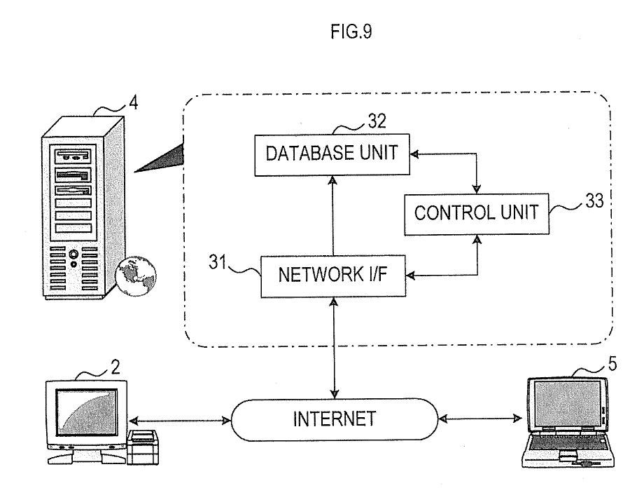

Next, as shown in FIG. 9, the management server 4 includes a network I/F 31, a database unit 32, and a control unit 33. The network I/F 31 is an interface for connecting the Internet. The database unit 32 accumulates the work information received from the issuing terminal 2 via the network I/F 31. The control unit 33 retrieves necessary information from the work information accumulated in the database unit 32 in accordance with a command sent from the management PC 5 connected to the Internet via the network I/F 31.

When receiving the work information from the issuing terminal 2 via the network I/F 31, the control unit 33 aggregates a service time and a waiting time on a time-series basis for each store 10 (and for each employee ID). The service time is a time period from the service start time till the service end time. The waiting time is a time period from the visiting time till the service start time. The control unit 33 is configured, by counting the service time and the waiting time as above, to aggregate a number of served visitors and a number of waiting visitors per unit time for each store 10 (and for each employee ID) and to aggregate the service time and the number of served visitors while associating the both with the content of service.

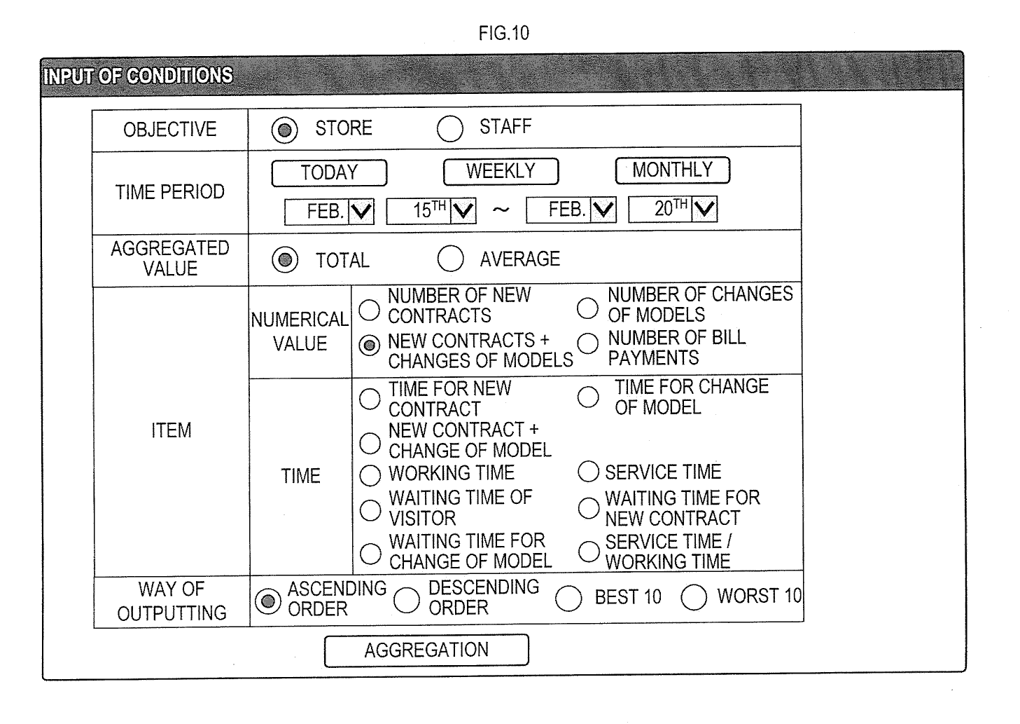

When obtaining the arrival time and the departure time of each employee from the fingerprint authentication device 6 via the network I/F 31, the control unit 33 aggregates a working time based on the arrival time and the departure time while associating the working time with the employee ID. Further, the control unit 33 is configured, when receiving the predetermined ID and the predetermined password from the management PC 5 via the network I/F 31, to display a screen (see FIG. 10) for accepting an input regarding conditions of presenting the aggregated data on the management PC 5.

Thus, the management server 4 is enabled to notify the management PC 5 of the following information, for example, in real time in accordance with an input command from the management PC 5:

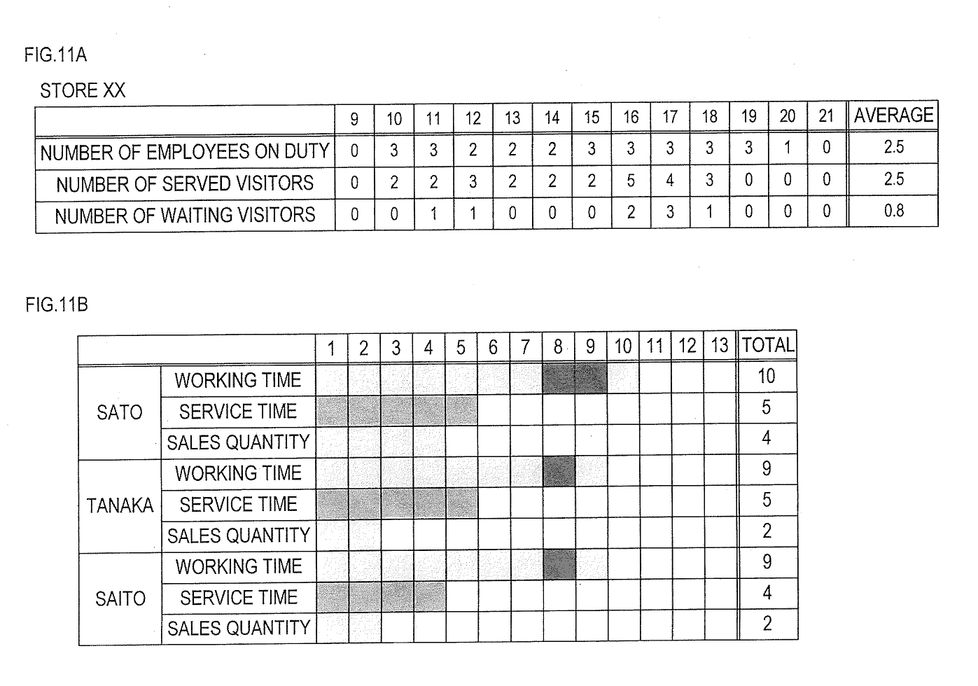

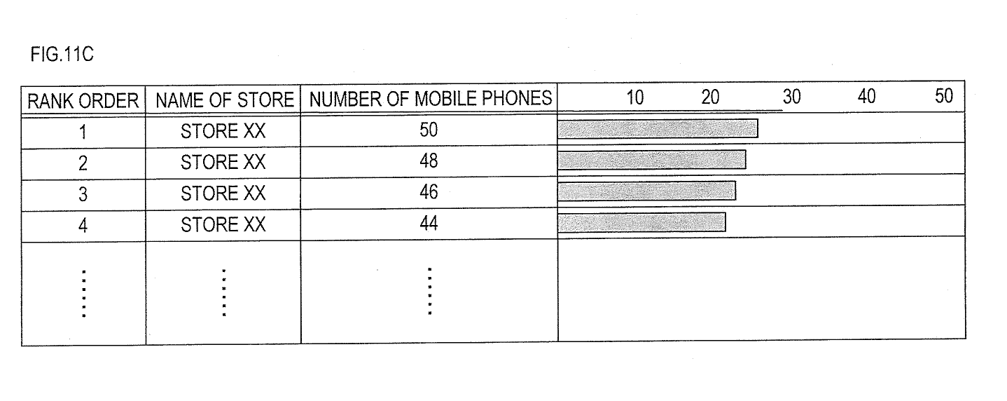

A number of employees on duty, the number of served visitors, and the number of waiting visitors in each store 10 at each clock time (see FIG. 11A).

The working time, the service time, and a sales quantity (new contract, change of a model, and the like) of each employee (see FIG. 11B).

A sales quantity in each store 10 (see FIG. 11C).

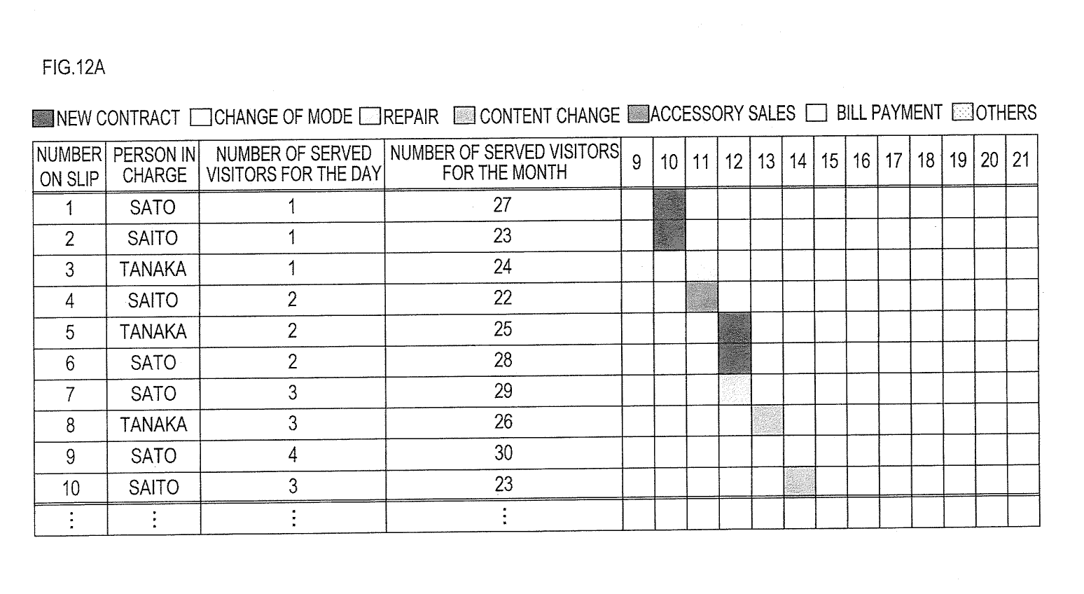

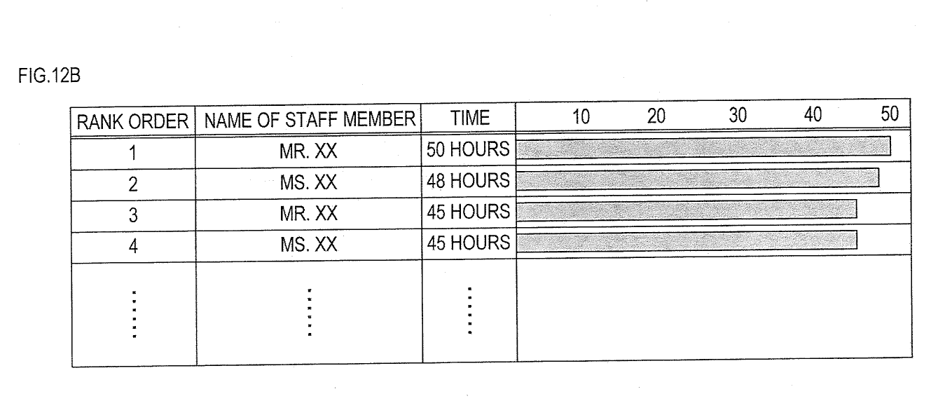

The content of service provided by each employee at each clock time (see FIG. 12A).

A data in which the employees are rearranged in order of the amount of working time, for example (see FIG. 12B).

<Effects>

As explained above, in the business management system 1 of the present embodiment, to have the management part comprehend the service time (the number of served visitors) and the waiting time (the number of waiting visitors) aggregated by the management server 4 for each store 10 enables the management part to evaluate effectiveness such as whether or not works are effectively performed in each store 10 based on a ratio of the service time to the waiting time, for example, for each store 10.

Consequently, according to the business management system 1 of the present embodiment, it becomes possible for the management part to easily adjust a number of employees (human resources) in each store 10 as mentioned above based on the evaluation regarding effectiveness (work evaluation) for each store 10. Therefore, the management part can allocate management resources easily and effectively to a plurality of the stores 10.

In addition, according to the business management system 1, to have the management part comprehend the content of service at each clock time aggregated by the management server 4 for each employee enables the management part to evaluate processing capability of each employee. Consequently, the management part can allocate the human resources to the plurality of stores 10 more properly.

Furthermore, according to the business management system 1, to have the management part comprehend the working time and the service time aggregated by the management server 4 for each employee enables the management part to evaluate work attitude of each employee. Consequently, the management part can easily carry out a salary assessment of each employee, for example.

### Second Embodiment

Next, a second embodiment of the present invention is explained with reference to the drawings.

A business management system 1 of the second embodiment is different from that of the first embodiment in that an inventory management and a cash flow management are performed in addition to the business management. Here, explanation is to be made focusing on such differences, and features common with the first embodiment are not to be explained.

Firstly, in the business management system 1 of the second embodiment, the control unit 25 of the handy terminal 3 is configured to execute an inventory-taking processing in addition to the service preparation processing and the service-at-the-window processing. Further, the control unit 33 of the management server 4 is configured to execute a warehousing processing and a pricing processing. In this regard, various menus displayed on the display unit 24 of the handy terminal 3 include an inventory-taking button for executing the inventory-taking processing.

Specifically, the inventory-taking processing is initiated when the inventory-taking button is depressed via the input unit 21 among the menus displayed on the display unit 24. When this processing is started, the goods identification code for identifying the goods ID assigned to each goods in advance is read via the reading unit 22 under control of the control unit 25 of the handy terminal 3. As a result, a number of times the goods ID has been inputted is counted as a quantity of inventory of the goods corresponding to the goods ID, and the quantity of inventory is stored (updated) in a predetermined area (first storage area) of the RAM while associating the quantity of inventory with the goods ID. Then, information of the quantity of inventory of the goods updated and stored in the first storage area is associated with the goods ID to generate inventory information. Subsequently, the inventory information is transmitted to the issuing terminal 2 via the communication unit 23.

In the business management system 1 of the second embodiment, the control device 14 of the issuing terminal 2 is configured, when receiving the inventory information from the handy terminal 3 via the communication device 16, to transfer the inventory information to the management server 4 via the network I/F 17. The control unit 33 of the management server 4 is configured, when receiving the inventory information from the issuing terminal 2 via the network I/F 31, to aggregate the quantity of inventory of each goods in each store 10 based on the inventory information.

In the warehousing processing, when a number of each goods to be warehoused in each store 10 is inputted by the management PC 5, the management server 4 generates warehousing information while associating the number of the goods to be warehoused with the goods ID, and transmits the warehousing information to the issuing terminal 2 via the network I/F 31. Further, in the pricing processing, the management server 4 is configured, when the sales price of each goods is inputted by the management PC 5, to generate price information while associating the sales price of the goods with the goods ID, and to transmit the price information to the issuing terminal 2 via the network I/F 31.

In the business management system 1 of the second embodiment, when receiving the warehousing information or the price information from the management server 4 via the network I/F 17, the control device 14 of the issuing terminal 2 transfers the received information to the handy terminal 3 via the communication device 16. The control unit 25 of the handy terminal 3 is configured, when receiving the warehousing information from the issuing terminal 2 via the communication unit 23, to add the number of the goods to be warehoused to the quantity of inventory of the goods corresponding to the goods ID, which is stored in the first storage area of the RAM, based on the warehousing information.

In the RAM of the control unit 25 of the handy terminal 3, a second storage area that stores the sales price of the goods corresponding to the goods ID is provided. The handy terminal 3 is configured, when receiving the price information from the issuing terminal 2 via the communication unit 23, to update the sales price of the goods corresponding to the goods ID, which is stored in the second storage area of the RAM, based on the price information.

<Effects>

As explained above, according to the business management system 1 of the second embodiment, the quantity of inventory of the goods in the store 10 can be counted just by the employee passing the reading unit 22 of the handy terminal 3 over the goods identification code affixed to each goods. This facilitates the inventory-taking in the store 10.

According to the business management system 1, the employee does not need to perform a process of warehousing the goods. Since the quantity of inventory of the goods stored in the handy terminal 3 is automatically updated, it can save the employee the trouble associated with the process of warehousing, and the time spent by the employee on other than the service at the window (the time spent on back-office works) can be reduced.

Further, according to the business management system 1, the sales price of each goods decided by the management part can be promptly reflected in each store 10. Since the employee does not need to perform a process of inputting the sales price and the sales price of the goods stored in the handy terminal 3 is automatically updated, miscommunication from the management part to a part of the store 10 can be avoided, and the management part can manage the sales price in each store 10 effectively.

### Other Embodiments

Although the embodiments of the present invention have been explained hereinbefore, the present invention is not limited to the above embodiments and can be implemented in various forms within a scope that does not depart from the spirit of the present invention.

For example, in the above embodiment, a break button and a work button may be displayed on the display unit 24 of the handy terminal 3. The break button is a button for inputting a rest period of the employee (more specifically, a rest start time and a rest end time). The work button is a button for inputting a time at which the employee stops the service at the window during other than the rest period (start time) and a time at which the employee restart the service at the window (end time). In this regard, a time (period) in which the employee is not working at the window during other than the rest period is referred to as a back-office period.

When the break button and the work button is depressed via the input unit 21 of the handy terminal 3, the handy terminal 3 transmits the rest period (start time and end time) and the back-office period (start time and end time), respectively, to the issuing terminal 2 via the communication unit 23. That enables the management server 4 to obtain the rest period, the back-office period, and the like for each employee from the handy terminal 3 via the issuing terminal 2 while associating the rest period, the back-office period, and the like with the employee ID. As a result, the management part can comprehend contents of work or the work attitude of each employee of each store 10.

In the business management system 1 of the above embodiment, the thermal printer 15 may be configured to print out a receipt in accordance with a command from the handy terminal 3. Furthermore, a POS button may be included in the various menus displayed on the display unit 24 of the handy terminal 3. The POS button is a button that starts a processing for realizing known POS functions. In a case where the POS button is depressed via the input unit 21, the handy terminal 3 may be so configured that, when the goods ID is inputted via the reading unit 22, the sales price is displayed on the display unit 24 and/or the quantity of inventory is reduced.

In the business management system 1 of the above embodiment, the handy terminal 3 may execute processings concerning warehousing, delivery and transfer of the goods, and inventory inquiry.

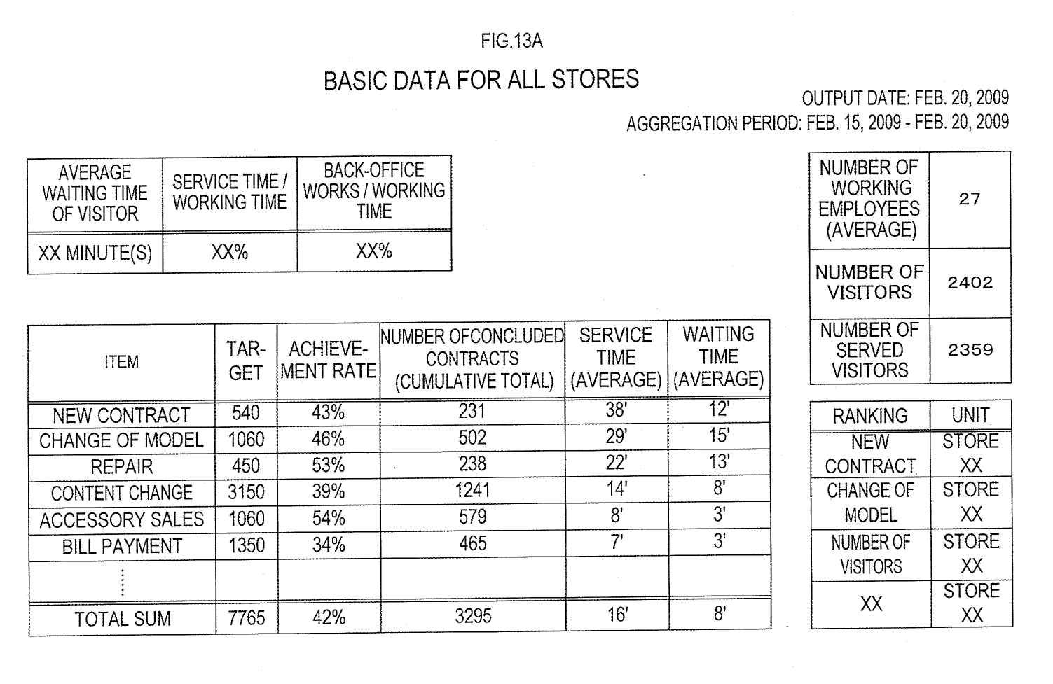

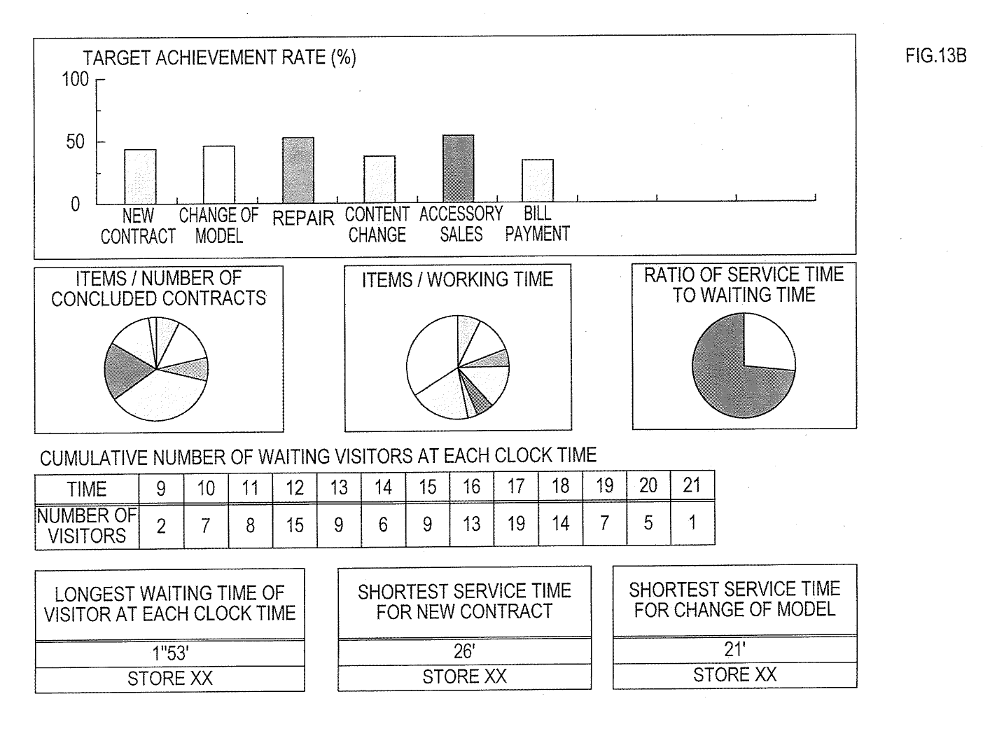

Further, in the business management system 1 of the above embodiment, the management server 4 may periodically notify the management PC 5 of information in accordance with a predetermined report format as shown in FIG. 13, for example.

In the business management system 1 of the above embodiment, the issuing terminal 2 may transmit the visiting time to the handy terminal 3 together with the visitor number.

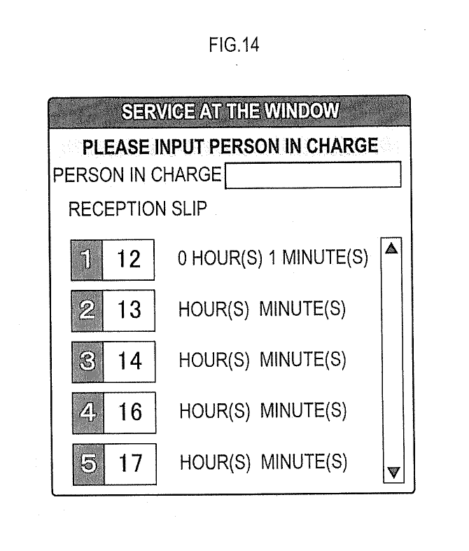

In this case, as shown in FIG. 14, by storing the visiting time received from the issuing terminal 2 while associating the visiting time with the visitor number, the handy terminal 3 is enabled to display, on the display unit 24, the waiting time of the visitor corresponding to the visitor number when the visitor number is inputted via the reading unit 22. In such a case, the employee can know the waiting time of the visitor prior to providing service, whereby how to serve the visitor can be planned based on the waiting time.

In the business management system 1 of the above embodiment, the handy terminal 3 may be configured to wirelessly transmit the service start time and the service end time directly to the management server 4. Furthermore, the handy terminal 3 may be a fixed terminal device that performs wired communications with the issuing terminal 2 or the management server 4.

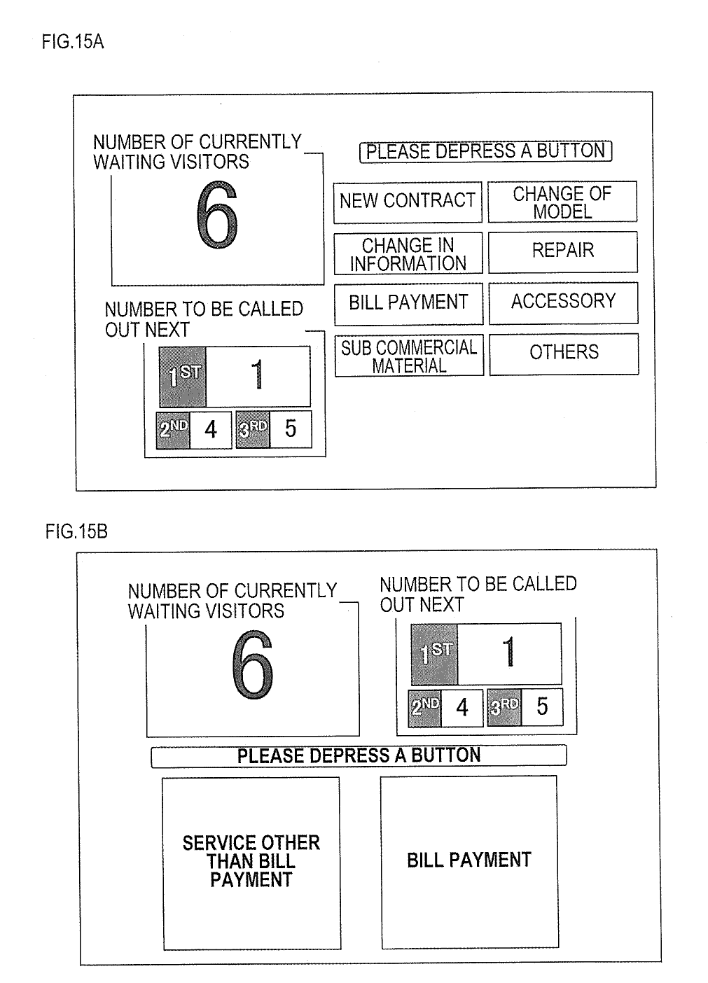

The display screen of the display panel 11 of the issuing terminal 2 is not limited to the one in the above embodiment but may be displayed as shown in FIG. 15A or FIG. 15B, for example.

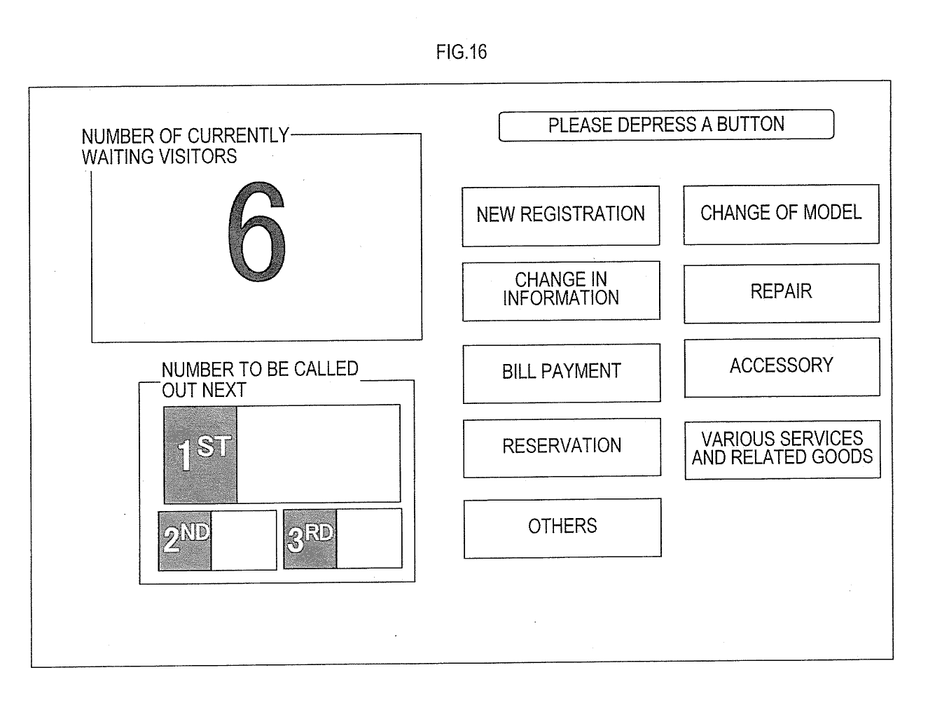

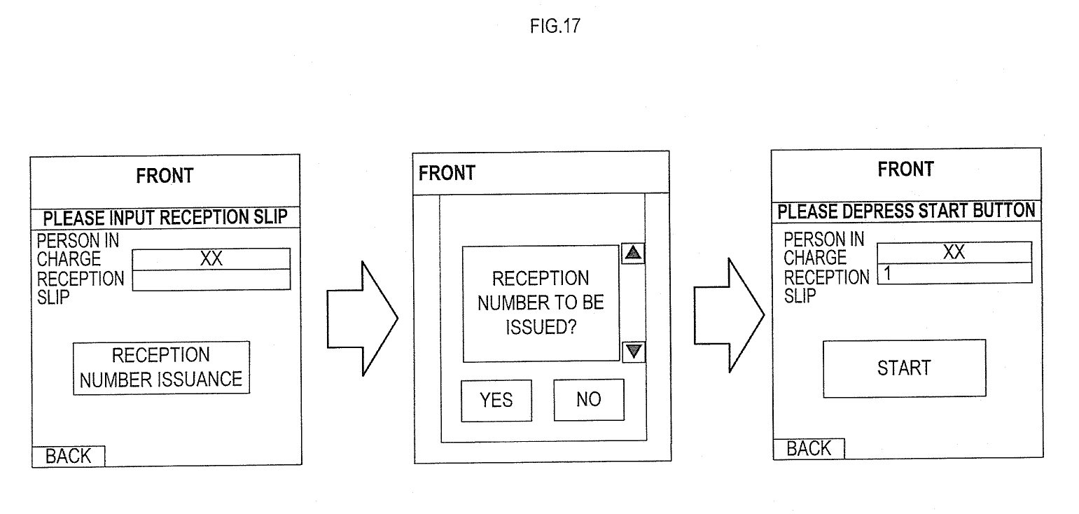

FIGS. 16-22 are drawings showing display forms in other embodiments.

FIG. 16 is a drawing showing another example of a display screen of the display panel 11 of the issuing terminal 2.

On the display panel 11 of the issuing terminal 2, the number of waiting visitors, the to-be-served visitor numbers (reception slip numbers), and the service items are displayed.

The number of waiting visitors is a number of the visitors who are waiting to be served. When there is no waiting visitor, “0” is displayed as shown in FIG. 16. To-be-served visitor number (reception slip number) is a number issued for each visitor, and indicates the visitor to be led to the window (space for serving visitors) of the store 10. The service items indicate contents of service that can be provided to the visitor. Specifically, the items includes new registration (new contract), change of a model, change in information, repair, bill payment, accessories, reservation, various services and related goods, others, and the like.

FIG. 17 is a drawing showing other examples of the screens displayed on the display unit 24.

On the display unit 24, a reception number issuance button for issuing the to-be-served visitor number (reception slip number) can be displayed firstly, together with an item of a person in charge. When an item of reception number issuance is depressed by the employee, a processing for the to-be-served visitor number (reception slip number) is started.

When the processing is started, a screen for confirming whether to issue the to-be-served visitor number (reception slip number) is displayed on the display unit 24. Then, when a button that indicates consent to issuance is depressed by the employee, the to-be-served visitor number (reception slip number) is issued.

Subsequently, a screen for confirming a start of the service is displayed. When a button indicating the start is depressed by the employee, the screen is moved to that for providing services.

As above, it is also possible to receive the visitor by means of the handy terminal 3. In other words, it is possible to have the handy terminal 3 bear part of functions of the issuing terminal 2. Due to this, even when the visitor directly comes to the employee at a counter without operating the issuing terminal 2, the employee can perform a process of reception and provide a service. Therefore, a quality of service can be further improved.

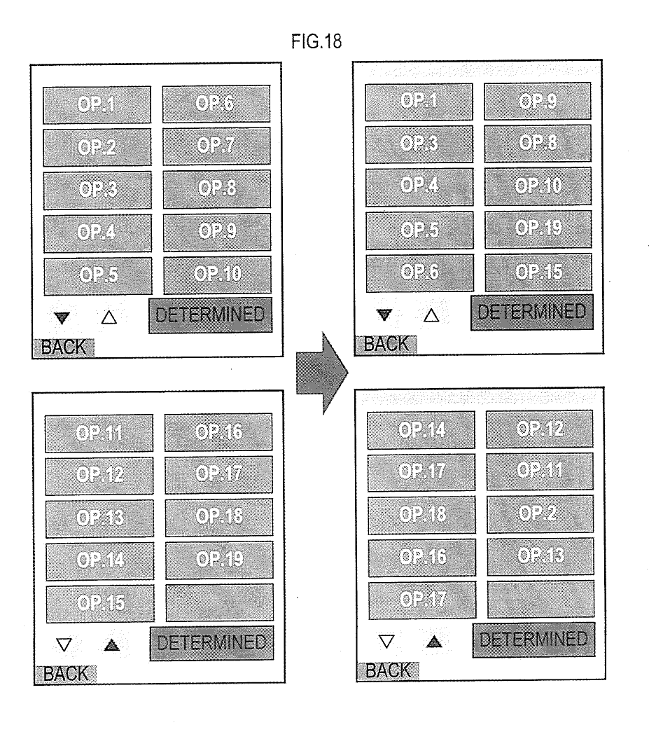

FIG. 18 is a drawing showing screens displayed on the display unit 24 and related to options. On the display unit 24 of the handy terminal 3, options screens as shown in FIG. 18 can be displayed. The options refer to additional services that are available to a mobile phone user. On the options screen, the employee can choose the option that the employee has explained to the visitor. Further, on the options screen, the employee can choose the option that the visitor has been led to purchase. Due to this, data about the option that has been explained to the visitor and the option that has been led to be purchased by the visitor can be aggregated. The results of the aggregation can be browsed on the screen of the management PC 5.

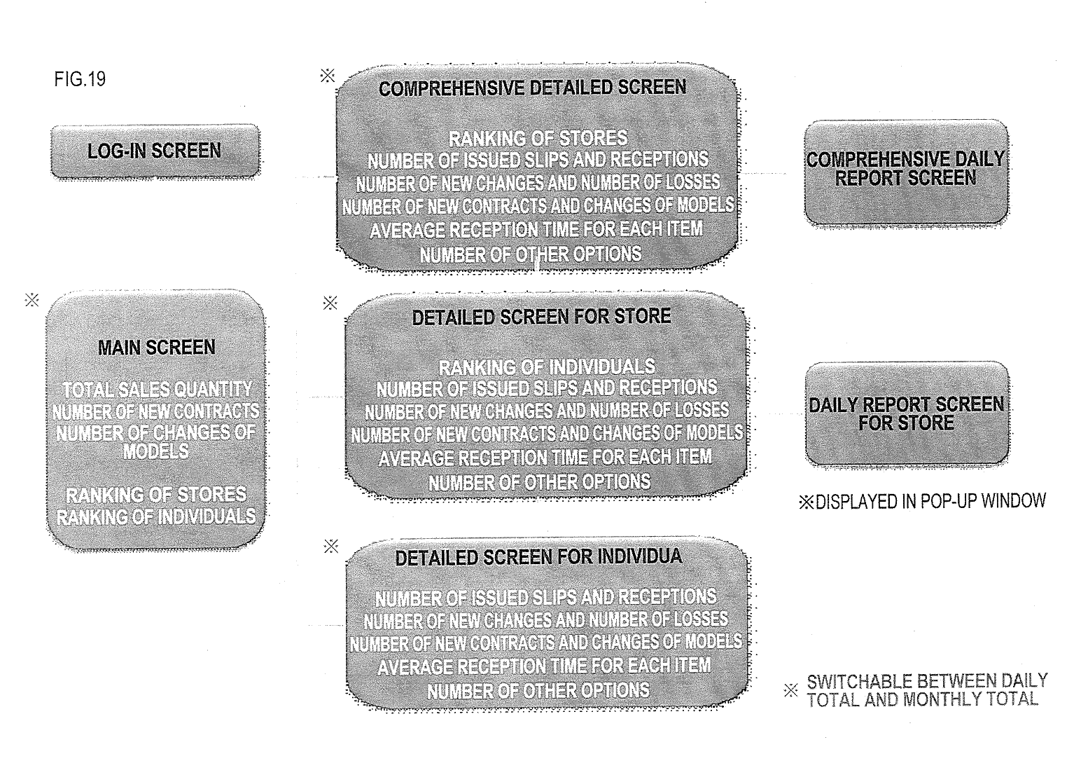

Subsequently, FIG. 19 is a drawing showing display contents in the management PC 5. In other words, FIG. 19 shows contents of information managed in the management server 4.

When the management PC 5 is initiated, a log-in screen is displayed on the display screen of the management PC 5. On the log-in screen, an entry screen (not shown) for entering the ID and the password is displayed.

The ID and the password entered to the management PC 5 are transmitted to the management server 4. The management server 4 authenticate whether the ID and the password received from the management PC 5 are legitimate or not. When the authentication is successful, the management server 4 allows the management PC 5 to browse various data stored in the management server 4 and to execute various programs stored in the management server 4.

In the management PC 5, when the log-in is successful, a main screen is displayed. On the main screen, a total sales quantity is displayed. The total quantity is a combined number of new contracts and changes of models. The number of new contracts and the number of changes of models are also displayed separately.

On the main screen, a sales quantity for each store is displayed. Further, a ranking of stores showing ranks of stores with large sales quantity is also displayed. On the main screen, a sales quantity of each employee and a ranking of individuals showing ranks of employees with large sales quantity are also displayed.

In the management PC 5, it is possible to move from the main screen to each of a comprehensive detailed screen, a detailed screen for store, and a detailed screen for individual.

On the comprehensive detailed screen, the ranking of stores as described above is displayed.

Moreover, information on a number of issued slips (number of receptions), a number of changes of contracts (number of losses), a number of new contracts, a number of changes of models, an average reception time, a number of options, and the like is displayed. On the comprehensive detailed screen, such information is displayed in aggregate total including all the information of the stores under management.

The number of issued slips (number of receptions) is information showing a cumulative total of the visitors. The number of changes of contracts (number of losses) is information showing a number of contracts that have been moved to other company (carrier). The number of new contracts is information showing a number of newly signed contracts. The number of changes of models is information showing a number of changes of only models of mobile phones with the company (carrier) unchanged. The mean reception time is information showing a time period from reception till actual service (waiting time). Such information on waiting time can be displayed for each service item. The number of options is information showing a number of explanations to the visitors about the options, a number of new purchases of the options, and the like. Incidentally, the comprehensive detailed screen can be further moved to a daily report screen. On the daily report screen, information per day is displayed.

On the detailed screen for store, the above-described ranking of individuals is displayed.

Moreover, information on a number of issued slips (number of receptions), a number of changes of contracts (number of losses), a number of new contracts, a number of changes of models, a mean reception time, a number of options, and the like is displayed. On the detailed screen for store, such information is displayed as separate information for each store. Incidentally, the detailed screen for store can be further moved to the daily report screen. On the daily report screen, information per day is displayed.

On the detailed screen for individual, information on a number of changes of contracts (number of losses), a number of new contracts, a number of changes of models, a mean reception time, a number of options, and the like is displayed. On the detailed screen for individual, such information is displayed as separate information for each employee.

Each of the information displayed on the main screen, the comprehensive detailed screen, the detailed screen for store, and the detailed screen for individual can be displayed in any form of aggregate data per day and aggregate data per month.

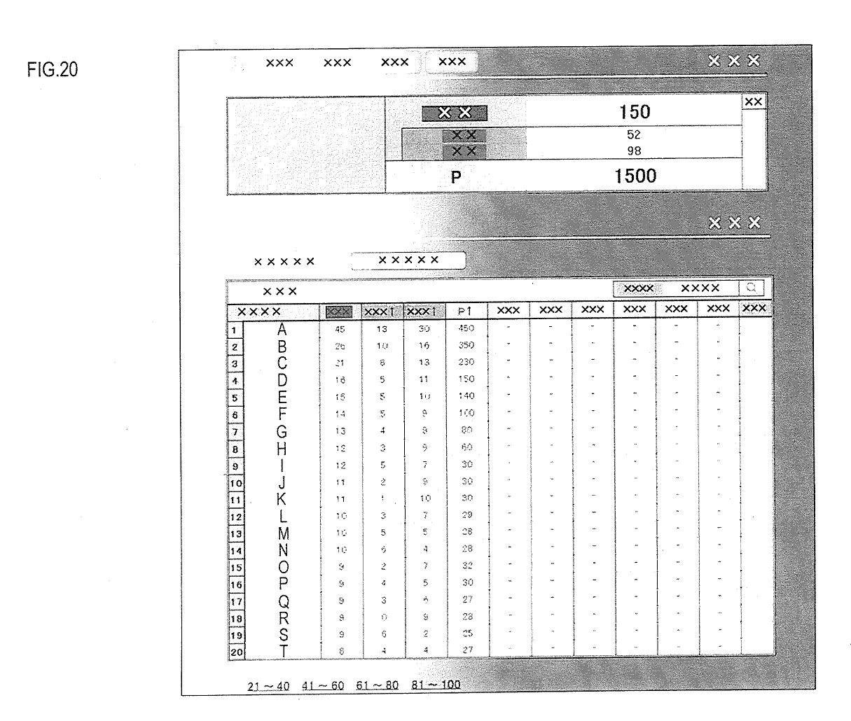

FIG. 20 is a drawing showing an example of the main screen.

In the upper part of the main screen, the total sales quantity is displayed. Further, a breakdown of the total sales quantity is also displayed. Specifically, each of the number of new contracts and the number of changes of models is displayed.

From the center to the lower part of the main screen, the ranking of stores is displayed. In the example of FIG. 20, stores up to the twentieth (stores ranked from the first to the twentieth) are displayed. By depressing a switching button located in the lower part of the main screen, stores ranked the twentieth and lower can be displayed in sequence. On the main screen, the ranking of individuals can be also displayed as described above. Specifically, an item button regarding the ranking of individuals is provided on the main screen, and it is so configured that the ranking of individuals is displayed when the button is depressed.

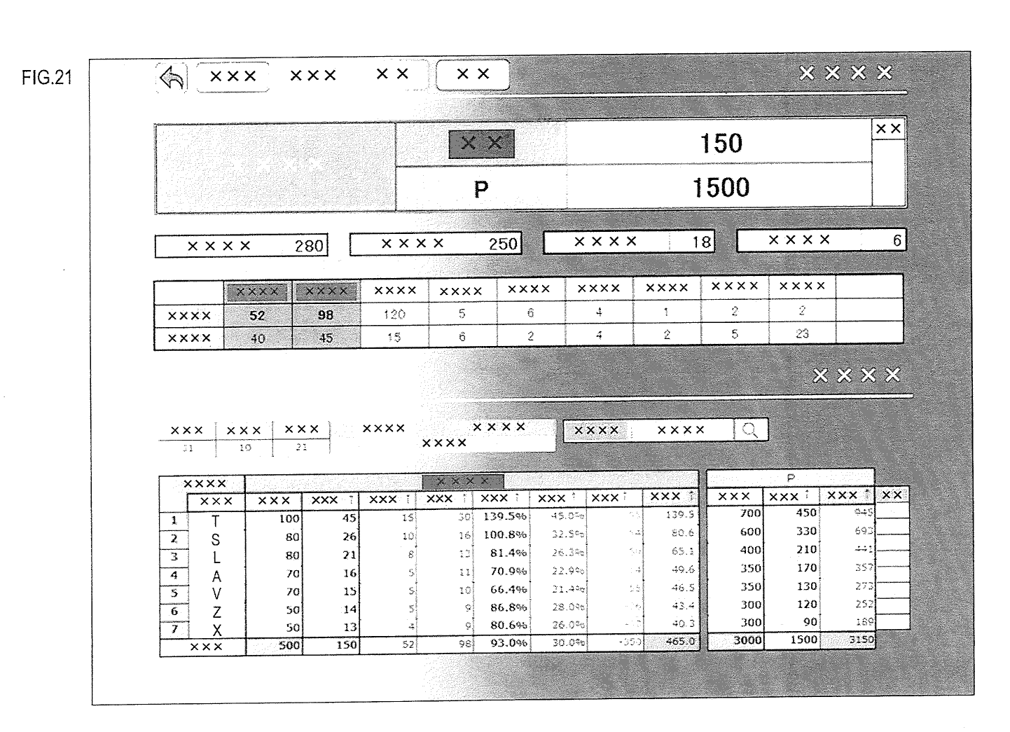

FIG. 21 is a drawing showing an example of the comprehensive detailed screen. In this example, information on progress is displayed in addition to the above-described information. The information on progress is information that shows degree of progress with respect to a target, and is displayed at a lower part than the center of the comprehensive detailed screen in FIG. 21.

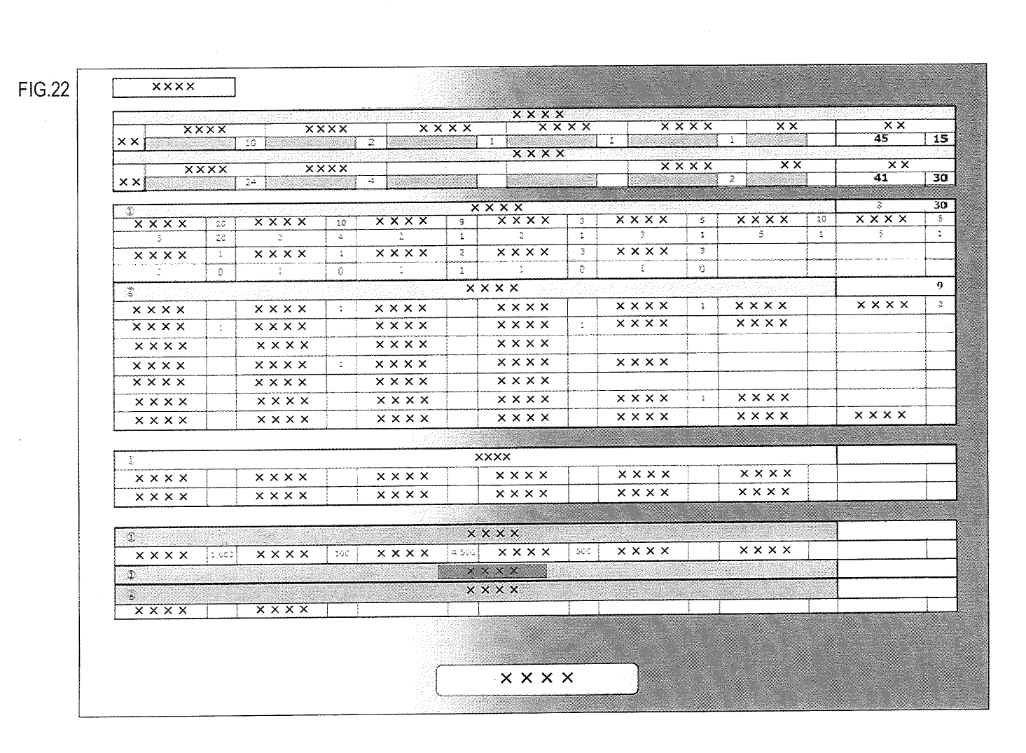

FIG. 22 is a drawing showing an example of the daily report screen that can be moved from the detailed screen for store. On this daily report screen, information of each number of mobile phones is displayed for each item. Specifically, the number of purchased options is displayed for each option item. Further, the number of mobile phones is displayed for each item such as a new contract and change of a model. Moreover, the number of mobile phones is also displayed for each content of repair and maintenance. Specifically, a number of receptions for each content of repair, i.e., what kind of repair is received, is displayed. In addition, information on accessories sold or the like is also displayed.

As explained above, the present invention can take various forms that can be assumed regarding the screen display.

In addition, the present invention can be applied to various stores such as a bank, a securities company, a post office, a hospital, a pharmacy, a public organization (government office), an auto dealer, a volume-sales electrical appliance store, a restaurant, a coffee house, an Internet café, a karaoke lounge, a comic café, a travel agency, an insurance agent, a beauty parlor, a gym, a pet shop.

1. A business management system that performs a business management of a plurality of stores, in which a service at the window is carried out, in a collective manner, the system comprising:
a first terminal device that:
sets a time at which a preset first operation performed by a visitor to the store is inputted via an input device installed in the store as a visiting time, and generates a visitor number used to sequentially lead the visitor to the window while associating the visitor number with the visiting time;
a second terminal device that inputs the visitor number generated by the first terminal device and a preset second operation performed by an employee of the store; and
a management server that:
sets a time at which the visitor number is inputted via the second terminal device as a service start time and a time at which the second operation is inputted as a service end time;
obtains a service time, which is a time period from the service start time till the service end time, and a waiting time, which is a time period from the visiting time till the service start time, and aggregates the service time and the waiting time on a time-series basis for each of the stores.

2. The business management system according to claim 1,
wherein the first terminal device is a fixed terminal device that performs wired communications with the management server, and
wherein the second terminal device is a portable terminal device that performs wireless communications with the fixed terminal device in the store.

3. The business management system according to claim 2,
wherein the portable terminal device transmits a first time information, which includes the service start time and the service end time, to the fixed terminal device while associating the first time information with the visitor number,
wherein, when receiving the first time information from the portable terminal device, the fixed terminal device transmits a second time information, in which the visiting time, the service start time, and the service end time are associated based on the visitor number, to the management server, and
wherein, when receiving the second time information from the fixed terminal device, the management server aggregates a number of served visitors and a number of waiting visitors per unit time for each of the stores by counting the service time and the waiting time.

4. The business management system according to claim 3,
wherein the fixed terminal device outputs a ticket having a visitor identification code affixed thereto to identify the visitor number, and
wherein the portable terminal device includes a reading unit that reads an identification code used to identify information, and inputs the visitor number by reading the visitor identification code affixed to the ticket via the reading unit.

5. The business management system according to claim 4,
wherein the portable terminal device inputs an employee ID, which has been assigned to each employee in advance, by reading an employee identification code used to identify the employee ID via the reading unit, and transmits the first time information to the fixed terminal device while associating the first time information with the employee ID,
wherein, when receiving the first time information from the portable terminal device, the fixed terminal device transmits a work information, in which the employee ID and the second time information are associated based on the visitor number, to the management server, and
wherein, when receiving the work information from the fixed terminal device, the management server aggregates the service time for each of the employee IDs.

6. The business management system according to claim 5,
wherein, when a content of service is inputted via the second operation, the portable terminal device transmits the first time information to the fixed terminal device while associating the first time information with the content of service,
wherein, when receiving the first time information from the portable terminal device, the fixed terminal device transmits the work information to the management server while associating the content of service with the work information based on the visitor number, and
wherein, when receiving the work information from the fixed terminal device, the management server aggregates the content of service while associating the content of service with the service time.

7. The business management system according to claim 4,
wherein the portable terminal device inputs a goods ID, which has assigned to each goods in advance, by reading a goods identification code used to identify the goods ID via the reading unit, and counts a number of times the goods ID has been inputted as a quantity of inventory of the goods corresponding to the goods ID, and
wherein the management server aggregates the quantity of inventory of each of the goods in each of the stores via the portable terminal device.

8. The business management system according to claim 7,
wherein the management server transmits a number of each of the goods to be warehoused to the fixed terminal device while associating the number of each of the goods to be warehoused with the goods ID, and
wherein the portable terminal device includes a first storage unit that stores the quantity of inventory of the goods corresponding to the goods ID and, when receiving the number of each of the goods to be warehoused via the fixed terminal device, the portable terminal device adds the number of each of the goods to be warehoused to the quantity of inventory of the goods corresponding to the goods ID, which is stored in the first storage unit.

9. The business management system according to claim 7,
wherein the management server transmits a sales price of each of the goods to the fixed terminal device while associating the sales price with the goods ID, and
wherein the portable terminal device includes a second storage unit that stores the sales price of the goods corresponding to the goods ID and, when receiving the sales price of each of the goods via the fixed terminal device, the portable terminal device updates the sales price of the goods corresponding to the goods ID, which is stored in the second storage unit.

10. The business management system according to claim 2,
wherein, when a service item is inputted via the first operation, the fixed terminal device transmits the visitor number to the portable terminal device while associating the visitor number with the service item, and
wherein, when receiving the visitor number from the fixed terminal device, the portable terminal device displays the visitor number in numerical order for each of the service items.

11. A portable terminal device that:
performs wireless communications in a store, in which a service at the window is carried out, with a fixed terminal device, the fixed terminal device:
setting a time at which a preset first operation performed by a visitor to the store is inputted via an input device installed in the store as a visiting time, and
generating a visitor number used to sequentially lead the visitor to the window while associating the visitor number with the visiting time, and
constitutes a business management system that performs a business management of a plurality of the stores in a collective manner together with a management server that performs wired communications with the fixed terminal device and the fixed terminal device, the portable terminal device comprising:
an input device that inputs the visitor number generated by the fixed terminal device and a preset second operation; and
a transmission device that transmits, via the fixed terminal device, the visiting time, a service start time, and a service end time to the management server, the management server:
setting a time at which the visitor number is inputted via the input device as the service start time and a time at which the second operation is inputted as the service end time, and
aggregating a service time, which is a time period from the service start time till the service end time, and a waiting time, which is a time period from the visiting time till the service start time on a time-series basis.
